(19) United States
(12) Patent Application Publication
(10) Pub. No.: US 2026/0062022 A1
(43) Pub. Date: Mar. 5, 2026

(54) VEHICLE OBJECT AND TRAFFIC SIGNAL DETECTION SYSTEM

(71) Applicant: FCA US LLC, Auburn Hills, MI (US)

(72) Inventors: Ashish Bansal, Auburn Hills, MI (US); Pravin Vishwasrao Chopade, Auburn Hills, MI (US)

(21) Appl. No.: 18/818,878

(22) Filed: Aug. 29, 2024

(51) Int. Cl. B60W 50/14; G06V 10/56; G06V 20/58; G06V 40/10

(52) U.S. Cl. CPC B60W 50/14; G06V 10/56; G06V 20/584; G06V 40/10; B60W 2050/146; B60W 2420/403; B60W 2420/408; B60W 2520/105; B60W 2554/4029; B60W 2554/80; B60W 2555/60; B60W 2556/40

(57) ABSTRACT

A vehicle object and traffic signal detection system includes an object detection sensor of a vehicle, the object detection sensor is operable to detect living objects within a threshold distance from the vehicle, a traffic signal detector of the vehicle, the traffic signal detector operable to permit detection of a flashing, illuminated traffic signal, a display visible by an occupant of the vehicle, and a controller. The controller is communicated with the object detection sensor, the traffic signal detector and the display to provide a notification on the display when a flashing, illuminated traffic signal is detected and when a living object is detected within the threshold distance.

### FIELD

The present disclosure relates to a vehicle having a system for detecting objects near the vehicle and for detecting one or more states of an illuminated traffic signal.

### BACKGROUND

Navigating a vehicle through an intersection requires many decisions by a driver. Solid or continuous traffic light signals at intersections are generally well-understood by drivers and pedestrians, but flashing traffic lights can be confusing and distracting and sometimes require drivers to quickly make decisions on how to proceed. Pedestrian and other things including other vehicles at the intersection may be moving and the situations may be very dynamic. Further, parts of the vehicle create blind spots near the vehicle which are areas not in direct view by a driver.

### SUMMARY

In at least some implementations, a vehicle object and traffic signal detection system includes an object detection sensor of a vehicle, the object detection sensor operable to detect living objects within a threshold distance from the vehicle, a traffic signal detector of the vehicle, the traffic signal detector operable to permit detection of a flashing, illuminated traffic signal, a display visible by an occupant of the vehicle, and a controller. The controller is communicated with the object detection sensor, the traffic signal detector and the display to provide a notification on the display when a flashing, illuminated traffic signal is detected and when a living object is detected within the threshold distance.

In at least some implementations, the object detection sensor is a camera, a radar sensor or a lidar sensor. In at least some implementations, the traffic signal detector is a camera, a radar sensor or a lidar sensor.

In at least some implementations, the controller is communicated with memory having programming by which the controller can determine the existence of a flashing traffic light from data received from the traffic signal detector.

In at least some implementations, the object detection sensor has a working range that includes one or more blind spots of the vehicle.

In at least some implementations, a vehicle speed sensor communicated with the control system to provide an indication of vehicle speed, and wherein the notification includes a recommendation for vehicle speed.

In at least some implementations, a source of map data is communicated with the control system to provide a location of an intersection near the vehicle, or information relating to a geometry of an intersection near the vehicle.

In at least some implementations, a method of detecting pedestrians near an intersection having a flashing traffic light includes detecting that a traffic light is presenting a flashing signal, determining that an object is present in a predetermined area outside a vehicle, and providing a notification within the vehicle.

In at least some implementations, the predetermined area includes one or more blind spots relative to a driver of the vehicle. In at least some implementations, at least one of the one or more blind spots includes an area in front of the vehicle and below a hood of the vehicle.

In at least some implementations, detecting the flashing signal is accomplished with a traffic signal detector. In at least some implementations, the traffic signal detector also detects a color of the light emitted from the traffic signal.

In at least some implementations, the object is a living thing and a path of travel of the living thing is determined and the notification is provided as a function of the determined path of travel.

In at least some implementations, the method includes determining a color of light emitted from the traffic signal and wherein the notification is provided as a function of the color.

In at least some implementations, the method includes providing a second notification when the object is determined to no longer be in the predetermined area.

In at least some implementations, the method includes providing an image from a camera on the display, where the image includes a view of at least part of a blind spot in front of the vehicle.

In at least some implementations, the method includes determining a vehicle dynamic including a vehicle speed or a vehicle acceleration, and wherein the notification is provided as a function of the vehicle dynamic.

Further areas of applicability of the present disclosure will become apparent from the detailed description, claims and drawings provided hereinafter. It should be understood that the summary and detailed description, including the disclosed embodiments and drawings, are merely exemplary in nature intended for purposes of illustration only and are not intended to limit the scope of the invention, its application or use. Thus, variations that do not depart from the gist of the disclosure are intended to be within the scope of the invention.

### BRIEF DESCRIPTION OF THE DRAWINGS

FIG. 1 is a diagrammatic side view of a vehicle at an intersection with a traffic signal;

FIG. 2 is a schematic view of a system for providing information to a driver of a vehicle relative to a location with a flashing traffic signal;

FIG. 3 is a front view of a display of the system including information for the driver;

FIG. 4 is a front view of the display showing different information for the driver;

FIG. 5 is a flowchart of a method for detecting a flashing traffic signal

FIG. 6 is a flowchart for an object detection method; and

FIG. 7 is a flowchart for a method of providing information to a driver of a vehicle relative to a location with a flashing traffic signal.

### DETAILED DESCRIPTION

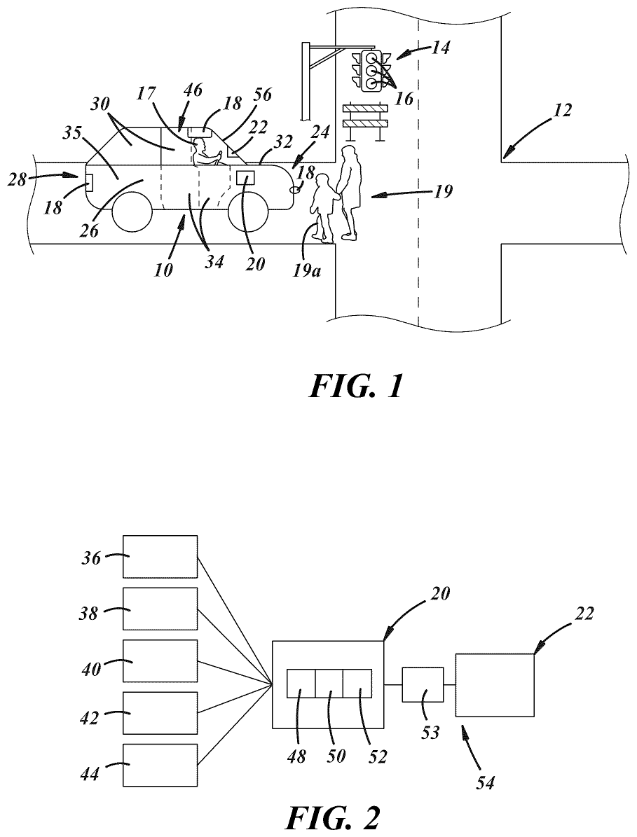

Referring in more detail to the drawings, FIG. 1 illustrates a vehicle 10 that is approaching an intersection 12 having an illuminated traffic light 14. The traffic light 14 may provide one or more signals and may have one or more lights 16 to provide the signal(s). For example, the lights 16 of the traffic light 14 may separately emit red, green and yellow light which indicate, respectively, for a driver 17 to stop, go or proceed through the intersection 12 or to slow or stop, if safe to do so. The traffic light 14 may instead emit a single color and that emitted light may be flashed on and off, that is, be intermittently provided at some predetermined frequency. In some jurisdictions, for example in the US, flashing yellow lights signify that a driver should proceed with caution through the intersection 12 and flashing red lights indicate that the vehicle 10 should be stopped before proceeding through the intersection 12. Solid or continuous traffic light signals are generally well-understood by drivers and pedestrians 19, but flashing traffic lights can be confusing and distracting and sometimes require drivers to quickly make decisions on how to proceed.

As shown in FIGS. 1 and 2, the vehicle 10 may one or more object detection sensors 18, a control system 20, and a display 22. One or more of the sensors 18 may be operable to detect the presence of a living thing or a living object, such as an animal or a pedestrian, within the working area of the sensor 18, which is the area in which a sensor is capable of sensing things. One or more of the sensors 18 may be operable to detect the presence of a traffic light 14, and may be called a traffic signal detector. The traffic signal detector may also determine a color of light emitted by the traffic light 14 and whether the emitted light is continuous or intermittent/flashing. The sensor(s) 18 that detect living things and the sensor(s) 18 that detect the traffic lights may be the same sensor or the same type of sensor. For example, one or more vision sensors (e.g. cameras) may be used to detect both living things and traffic lights. Further, radar, lidar, sonar sensors 18 may be used for one or both purposes. Such sensors emit a detection output (e.g. light or sound waves) and are responsive to detection inputs (e.g. reflected light or sound waves) to determine the presence of objects in the path of the emission(s).

As shown in FIG. 1, the detection sensors 18 may be mounted on the vehicle 10 so that the working or effective area monitored by the detection sensors 18 covers desired areas around the vehicle 10. For example, one or more forward-facing detection sensors 18 can be mounted near the front 24 of the vehicle 10 to view, sense or display the area in front of the vehicle 10 as well as areas to the sides of and in front of the vehicle 10. Detection sensors 18 may also or instead by mounted to the sides 26 of the vehicle 10 and to the rear 28 of the vehicle 10. The areas covered by the detection sensors 18 include various blind spots, which are areas outside the vehicle 10 that are not directly in view of a driver of the vehicle 10, when the driver is seated within the vehicle 10. In this regard, vehicle windows 30 provide areas through which a driver can view some of the area outside of the vehicle 10, but the windows 30 are of limited size and not all areas outside the vehicle 10 can readily be seen through the windows 30. For example, a hood 32 of the vehicle 10 blocks the driver's view of an area in front of the vehicle 10 and below the hood 32, vehicle doors/door panels 34 block the view of areas to the sides of the vehicle 10 and below a driver's line of sight through the bottom of a window 30 carried by the doors 34. Similarly, other portions of the vehicle 10 like a trunk, rear body panels 35 (e.g. in vehicles without a trunk) and the like can block a driver's view of certain areas outside of the vehicle 10, especially areas very close to the vehicle 10.

In addition to the object detection sensors 18, other sensors can be used to provide information to the control system 20. As shown in FIG. 2, as a vehicle speed sensor 36 and an accelerometer 38 provide information about vehicle dynamics. Other data sources may be available to the control system 20 and provide information about the area near the vehicle 10, such as a GPS unit 40 and map data 42 which may be stored in the memory or provided from a remote source, and which may include information about the location of intersections, type of traffic signals present at intersections, if any, and the like. Any data sources that are remotely located (e.g. not in the vehicle) may be communicated with the vehicle 10 in any suitable manner, such as via a cellular or other wireless network and via a communications device 44 (e.g. telematics unit) of the vehicle 10.

The display 22 may be provided in the vehicle 10, such as within a passenger compartment 46 (FIG. 1) of the vehicle 10, and may be coupled to one or more cameras 18 to provide a view of the area to be traversed by the vehicle 10. The camera(s) 18 and display 22 may be coupled to the control system 20 which may include, as shown in FIG. 2, a processor 48 and memory 50 that includes executable programs 52 or instructions. The display 22, processor 48 and memory 50 may be of suitable types and such components in vehicles are well-known and will not be further described herein.

To perform the functions and desired processing set forth herein, as well as the computations therefore, the control system 20 may include, but is not limited to, one or more controller(s), control unit(s), processor(s), computer(s), DSP(s), memory, storage, register(s), timing, interrupt(s) (generally referred to by reference numeral 48), communication interface(s), and input/output signal interfaces, and the like, as well as combinations comprising at least one of the foregoing. For example, the control system 20 may include input signal processing and filtering to enable accurate sampling and conversion or acquisitions of such signals from communications interfaces and sensors. As used herein the terms control system 20 may refer to one or more processing circuits such as an application specific integrated circuit (ASIC), an electronic circuit, a processor (shared, dedicated, or group) and memory that executes one or more software or firmware programs, a combinational logic circuit, and/or other suitable components that provide the described functionality. The control system 20 may be distributed among different vehicle modules, such as an infotainment system control module 53, engine control module or unit, powertrain control module, transmission control module, and the like, if desired.

The term “memory” 50 or “storage” as used herein can include computer readable memory, and may be volatile memory and/or non-volatile memory. Non-volatile memory can include, for example, ROM (read only memory), PROM (programmable read only memory), EPROM (erasable PROM), and EEPROM (electrically erasable PROM). Volatile memory can include, for example, RAM (random access memory), synchronous RAM (SRAM), dynamic RAM (DRAM), synchronous DRAM (SDRAM), double data rate SDRAM (DDR SDRAM), and direct RAM bus RAM (DRRAM). The memory 48 can store an operating system and/or instructions/programs 52 executable by a processor or controller or the like to enable control or allocate resources of a computing device.

As shown in FIG. 2, the display 22 may be part of a vehicle Human-Machine Interface, such as an infotainment system 54 and may be located on or near a vehicle dashboard/instrument panel. Such displays may be called “heads-down” displays because they require a driver to lower their viewing angle from looking outward through a windshield 56 (FIG. 1) downward and within the vehicle 10 to see the display 22. The display 22 may also or instead be provided as a so-called heads-up display (HUD) that is provided (e.g. projected) on the windshield 56 of the vehicle 10.

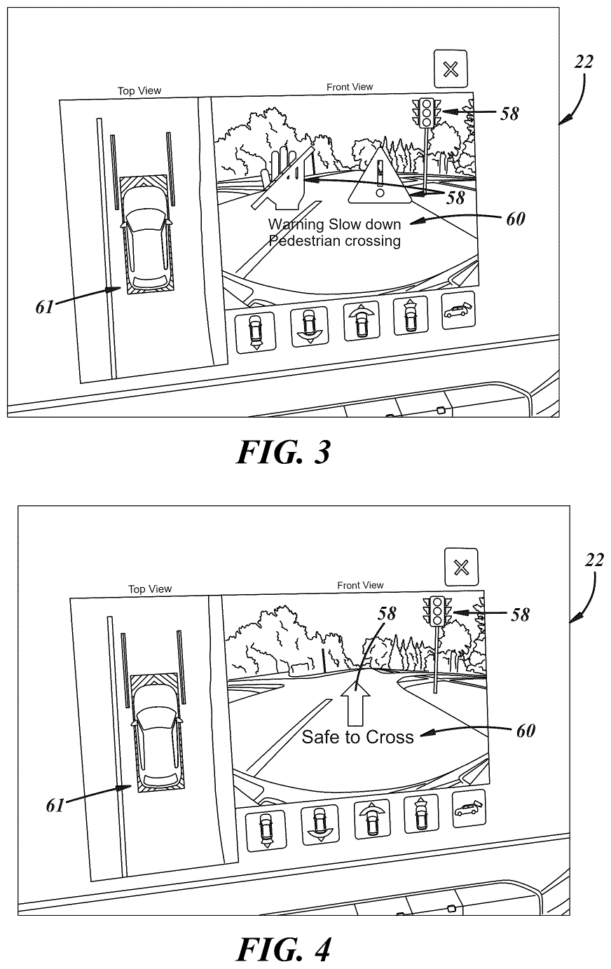

With a heads-up display 22, the information displayed can be viewed by a driver along with the environment outside the vehicle 10 and in view through the windshield 54. In at least some implementations, the information on the heads-up display 22 may include one or more graphics 58 (FIGS. 3 and 4) and text 60 to indicate the presence of objects and living things and provide guidance to a driver regarding recommendations for proceeding through an intersection 12 that includes a flashing traffic light 14. Additionally, a live feed 61 from one or more cameras or other object detection sensors 18 may be provided on part of the display to show the driver an area around at least part, and up to all of the vehicle, including blind spots immediately adjacent to the vehicle and not directly visible by the driver. The live feeds shown in FIGS. 3 and 4 are stitched together images from different cameras 18 of the vehicle, and provide a 360-degree surrounding view of the area immediately outside the vehicle 10. Along with the graphics and text, a driver can quickly understand the environment outside the vehicle from the information displayed.

The control system 20 has inputs from the object detection sensors 18 which provide information regarding the presence of traffic lights 14, the operational status of the traffic lights 14 (e.g. solid or flashing, and what color light is being emitted), the speed of the vehicle 10, vehicle accelerations (e.g. slowing down or speeding up, or lateral/turning acceleration), the presence of objects including living things in a defined area around the vehicle 10 and the intersection 12, the travel path of moving things (e.g. people walking), and the like. For example, the control system 20 can determine not only the presence of people near the intersection 12, but their direction and speed of movement, to help determine if the paths of the people and vehicle 10 might intersect in which case the vehicle 10 should be slowed or stopped.

From the information provided, the control system 20 can determine whether and how the vehicle 10 should proceed to and through the intersection 12. For example, if the traffic light 14 is emitting an intermittent/flashing red light, then the vehicle 10 should stop before the intersection 12 and proceed through the intersection 12 when permitted by traffic rules or laws, and when it is safe to do so. In this situation, the information 58, 60 on the heads-up display 22 may inform the driver of the detected flashing red light traffic signal and advise the driver to stop before proceeding through the intersection 12. Further, if a living being or other object is detected in the area of the intersection 12, the location and presence thereof can be provided on the display 22 to inform the driver. Additionally, text or audible information may be provided to assist the driver in navigating the intersection 12 and with respect to the living being/detected object. The information provided may be shown on the display 22 overlaid on an image provided by a camera 18, as shown in the example of FIGS. 3 and 4.

Particularly at intersections 12 with flashing traffic signals 14, the situation for a driver is dynamic as any required stop is often momentary with the expectation of moving the vehicle 10 soon after. Further, flashing traffic signals 14 can be implemented in an emergency situation, such as a power outage, and increased traffic may result creating additional vehicles at the intersection 12 and pressure on the driver to make prompt decisions. With people and animals moving in and around the intersection 12, there are numerous factors to consider and decision to make. Especially smaller people or animals can be mostly or entirely obscured from a driver's view by the vehicle body such as but not limited to the front end of the vehicle 10. Larger SUVs and trucks, in particular, can have areas of significant size in front of and to the sides of the vehicles that are not within a driver's direct view, and the dynamic situations presented at flashing traffic signal intersections can make it difficult for a driver to fully understand their surroundings.

For example, many people 19 may cross the intersection 12 in front of or near the vehicle 10 and it can be difficult for a driver to determine if all of those people have fully moved out of the way of the vehicle 10. For example, a small child 19a (FIG. 1) or dog may have strayed from the group of people and stayed in the path of the vehicle 10 but out of the driver's sight, in a blind spot. The driver may additionally have to consider people walking near or across other portions of the intersection 12, and the path of travel for all people, with respect to the intended path of travel of the vehicle 10. For things within and outside a driver's view, the control system 20 can determine an appropriate driver action and communicate that to the driver via the display 22, or otherwise (e.g. audible instructions).

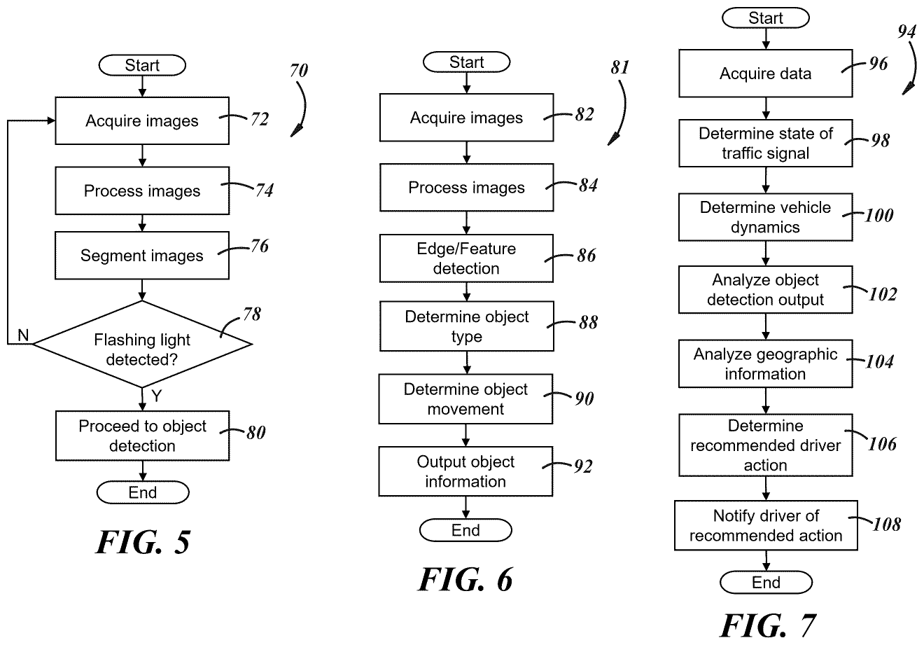

FIG. 5 shows a flowchart for a method 70 of detecting flashing light at a traffic signal. In step 72, images are acquired from a camera or other sensor. The images may be processed in step 74 to convert the images into an appropriate color space, and to reduce noise or otherwise enhance the image quality. Next, in step 76, the images can be segmented based on color thresholds relating to the colors of flashing traffic signals (e.g. reds and yellows). This enables candidate regions that might include traffic signals to be identified and compared in a series of images to determine if the light is flashing or not, as noted in step 78. This can be done, for example, by analyzing a temporal sequence of images to detect temporal changes in the candidate regions of the images, which may include filtering techniques such as frame differencing, to highlight regions with temporal changes. Such regions can be validated or further analyzed using geometric constraints and context information, such as the vehicle proximity to an intersection 12 or other area that might include a traffic signal. If validated, the location of the flashing lights in the camera image can be highlighted on the display 22 to alert the driver, and the system may then move to step 80 to consider whether any objects of interest (e.g. people) are in the area. If flashing light traffic signal is not detected, the method may loop back to step 72 to again look for a flashing light traffic signal.

FIG. 6 is a flowchart for a method 81 of detecting objects near the vehicle 10. In step 82, one or more images may be acquired from a camera or other sensor (this may be the same step and images acquired in step 72 of method 70). In step 84, the image(s) may be processed as desired to improve image quality or improve contrast to enable more accurate edge detection (e.g. Canny edge detection) to identify object boundaries. From this, in step 86, relevant features may be extracted from the detected edges, such as shape, size and texture. Feature descriptors (e.g., HOG—Histogram of Oriented Gradients features) may be used to represent the objects in a feature space, if desired. In step 88, the objects may then be compared to templates or other information to enable identification (e.g. detection and classification) of the objects (e.g. vehicle, pedestrian, animal, etc).

Next, in step 90, the objects may be tracked in successive images to determine if the objects are moving, and if so, their path of travel. In step 92, information regarding the objects and paths of travel are output, such as to the display 22. This may be done by highlighting (e.g. putting a box/polygon around) or otherwise calling out features in the camera feed provided on the display 22 so the driver is alerted to the presence of the features/objects.

FIG. 7 illustrates a method 94 of providing notifications or recommendations to a driver when a flashing traffic light 14 is detected, to aid in dynamic decision making by the driver. In step 96, real-time data is acquired by the control system 20 from cameras, sensors, and other data sources including information on traffic signal state, vehicle speed/acceleration, presence of objects of interest including obscured objects, and contextual factors like time of day and weather conditions which can affect visibility and the ability of the car to stop or maneuver effectively (e.g. icy conditions). From this information, in step 98, the state of any detected traffic signals can be determined (e.g. red, yellow, green and flashing or not), such as described above with regard to FIG. 5. In step 100, the vehicle speed and accelerations can be monitored to determine the vehicle dynamics as the vehicle 10 approaches the traffic signal, which dynamics can be assessed in view of the current traffic signal state. In step 102, object detection and assessment may be performed, such as described above with regard to FIG. 6. In step 104, other data sources may be considered to determine, for example, the vehicle 10 location (e.g. from GPS/map data) relative to the intersection 12, and intersection geometry (e.g. angle/orientation and number of roads at the intersection 12).

Then, in step 106, decision-making logic may be used to evaluate the combination of inputs (e.g. traffic signal state, vehicle speed, obscured objects, telematics data, and contextual factors) to determine the optimal course of action for the driver. In step 108, information is provided to the driver to assist the driver's decision making in negotiating an intersection 12 with a flashing traffic light 14. For example, the information may include instructions or recommendations to slow down or stop, as in FIG. 3, or proceed with caution, or alert the driver that it is safe to proceed, as shown in FIG. 4. In at least some implementations, the notification may include information that a living thing (i.e. a person or animal) is present within the vehicle path of travel or will be, based on a path of travel of the living thing, and a second notification may be provided when the living thing is no longer in the vehicle path of travel. In one example, FIG. 3 shows a possible first notification and FIG. 4 shows a possible second notification. Of course, the particular content and format of notifications can be selected as desired.

The system and methods described herein assist a driver in negotiating intersections 12 in dynamic situations, such as with flashing traffic signals 14, and with other vehicles, pedestrians, animals and other objects nearby being considered with regard to their impact on the vehicle's safe passage through the intersection 12. A wide range of factors can be considered and information quickly provided to a driver to assist the driver in navigating the vehicle 10 relative to the traffic signal/intersection 12. Particularly with regard to blind spots and things not directly in view of the driver, the system can help prevent unintended collisions between the vehicle 10 and objects.

What is claimed is:

1. A vehicle object and traffic signal detection system, comprising:
an object detection sensor of a vehicle, the object detection sensor is operable to detect living objects within a threshold distance from the vehicle;
a traffic signal detector of the vehicle, the traffic signal detector operable to permit detection of a flashing, illuminated traffic signal;
a display visible by an occupant of the vehicle; and
a control system communicated with the object detection sensor, the traffic signal detector and the display to provide a notification on the display when a flashing, illuminated traffic signal is detected and when a living object is detected within the threshold distance.

2. The system of claim 1 wherein the object detection sensor is a camera, a radar sensor or a lidar sensor.

3. The system of claim 2 wherein the traffic signal detector is a camera, a radar sensor or a lidar sensor.

4. The system of claim 1 wherein the traffic signal detector is a camera, a radar sensor or a lidar sensor.

5. The system of claim 1 wherein the control system is communicated with memory having programming by which the control system can determine the existence of a flashing traffic light from data received from the traffic signal detector.

6. The system of claim 1 wherein the object detection sensor has a working range that includes one or more blind spots of the vehicle.

7. The system of claim 1 which includes a vehicle speed sensor communicated with the control system to provide an indication of vehicle speed, and wherein the notification includes a recommendation for vehicle speed.

8. The system of claim 1 which includes a source of map data is communicated with the control system to provide a location of an intersection near the vehicle, or information relating to a geometry of an intersection near the vehicle.

9. A method of detecting pedestrians near an intersection having a flashing traffic light, comprising:
detecting that a traffic light is presenting a flashing signal;
determining that an object is present in a predetermined area outside a vehicle; and
providing a notification within the vehicle.

10. The method of claim 9 wherein the predetermined area includes one or more blind spots relative to a driver of the vehicle.

11. The method of claim 10 wherein at least one of the one or more blind spots includes an area in front of the vehicle and below a hood of the vehicle.

12. The method of claim 9 wherein detecting the flashing signal is accomplished with a traffic signal detector.

13. The method of claim 12 wherein the traffic signal detector also detects a color of the light emitted from the traffic signal.

14. The method of claim 9 wherein the object is a living thing and a path of travel of the living thing is determined and the notification is provided as a function of the determined path of travel.

15. The method of claim 9 which includes determining a color of light emitted from the traffic signal and wherein the notification is provided as a function of the color.

16. The method of claim 9 which also includes providing a second notification when the object is determined to no longer be in the predetermined area.

17. The method of claim 9 which also includes determining a vehicle dynamic including a vehicle speed or a vehicle acceleration, and wherein the notification is provided as a function of the vehicle dynamic.

18. The method of claim 9 which also includes providing an image from a camera on the display, where the image includes a view of at least part of a blind spot in front of the vehicle.
